(19) United States
(12) Patent Application Publication
(10) Pub. No.: US 2014/0214935 A1
(43) Pub. Date: Jul. 31, 2014

(54) Managing Content Across Different Device Types

(71) Applicant: INTERNATIONAL BUSINESS MACHINES CORPORATION, Armonk, NY (US)

(72) Inventors: Mark B. Stevens, Austin, TX (US); John D. Wilson, Houston, TX (US)

(73) Assignee: INTERNATIONAL BUSINESS MACHINES CORPORATION, Armonk, NY (US)

(21) Appl. No.: 13/752,081

(22) Filed: Jan. 28, 2013

(51) Int. Cl. H04L 29/06

(52) U.S. Cl. CPC H04L 65/403
USPC 709/204

(57) ABSTRACT

A method, system or computer usable program product for automatically navigating content on different devices using markers including identifying a set of device types for receiving content stored in memory, utilizing a processor to provide markers to the content, the markers being selective by device type, and displaying on a display a portion of the content on each device type according to the provided markers.

### BACKGROUND

1. Technical Field

The present invention relates generally to managing content, and in particular, to a computer implemented method for utilizing markers to manage content across different device types.

2. Description of Related Art

Presentations to local and remote devices are commonly performed today. Such presentations can include remote users logging onto a presentation system that is managed by a presenter. The remote users may also receive voice communications by web conferencing or through a separate voice communication system such as a teleconference. Such communications may be one way from the presenter or duplex so that the remote users can ask questions. Remote users may also be able to type questions through the presentation system.

Such presentations may be in the form of a slide show. As the presenter makes a presentation, he or she may indicate that a new slide is being viewed, which is then provided to the remote devices for viewing by the remote users. This allows the presenter control of the presentation and keeps the remote users viewing the slide being discussed.

### SUMMARY

The illustrative embodiments provide a method, system, and computer usable program product for automatically navigating content on different devices using markers including identifying a set of device types for receiving content stored in memory, utilizing a processor to provide markers to the content, the markers being selective by device type, and displaying on a display a portion of the content on each device type according to the provided markers.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of a data processing system in which various embodiments may be implemented;

FIG. 2 is a block diagram of a network of data processing systems in which various embodiments may be implemented;

FIGS. 3A and 3B are screen displays of content with markers in accordance with a first embodiment;

FIGS. 4A and 4B are screen displays of content with markers in accordance with a second embodiment;

FIG. 5 is a block diagram of a system for setting up and presenting content in which various embodiments may be implemented;

FIG. 6 is a flow diagram of the operation of a marking system in which various embodiments may be implemented; and

FIG. 7 is a flow diagram of the operation of a presentation management system in which various embodiments may be implemented.

### DETAILED DESCRIPTION

Processes and devices may be implemented to utilize markers to manage content across different device types. These processes and apparatuses may be implemented and utilized as will be explained with reference to the various embodiments below.

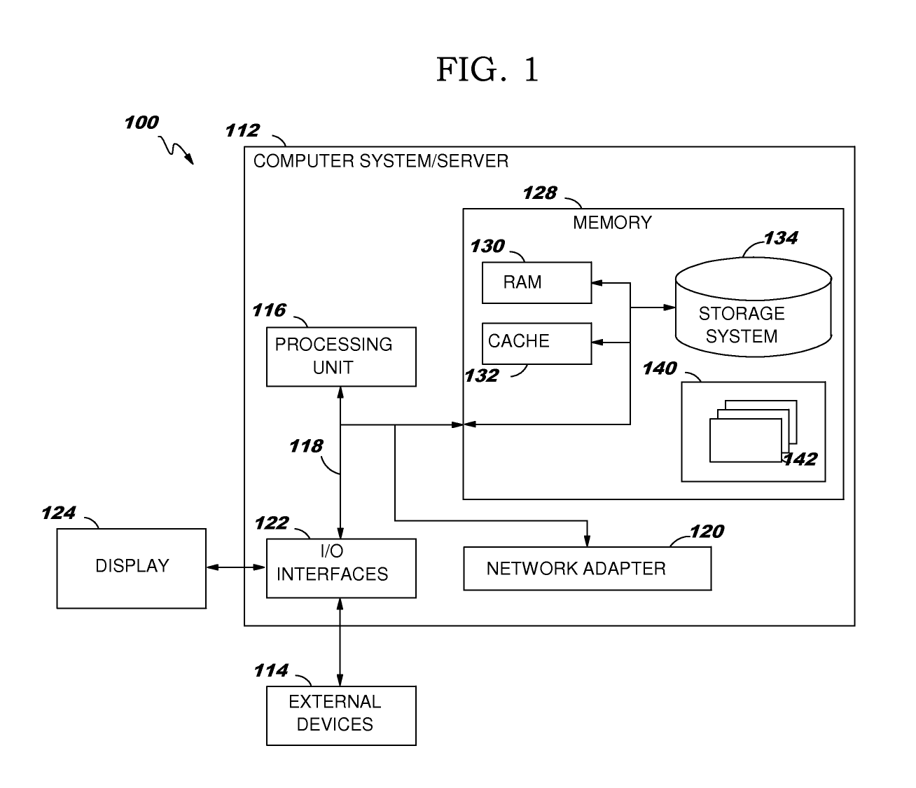

FIG. 1 is a block diagram of a data processing system in which various embodiments may be implemented. Data processing system 100 is one example of a suitable data processing system and is not intended to suggest any limitation as to the scope of use or functionality of embodiments of the invention described herein. Regardless, data processing system 100 is capable of being implemented and/or performing any of the functionality set forth herein.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, and it includes both volatile and non-volatile media, removable and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of embodiments of the invention. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of embodiments of the invention. For example, a program module may be software for utilizing markers to manage content across different device types.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

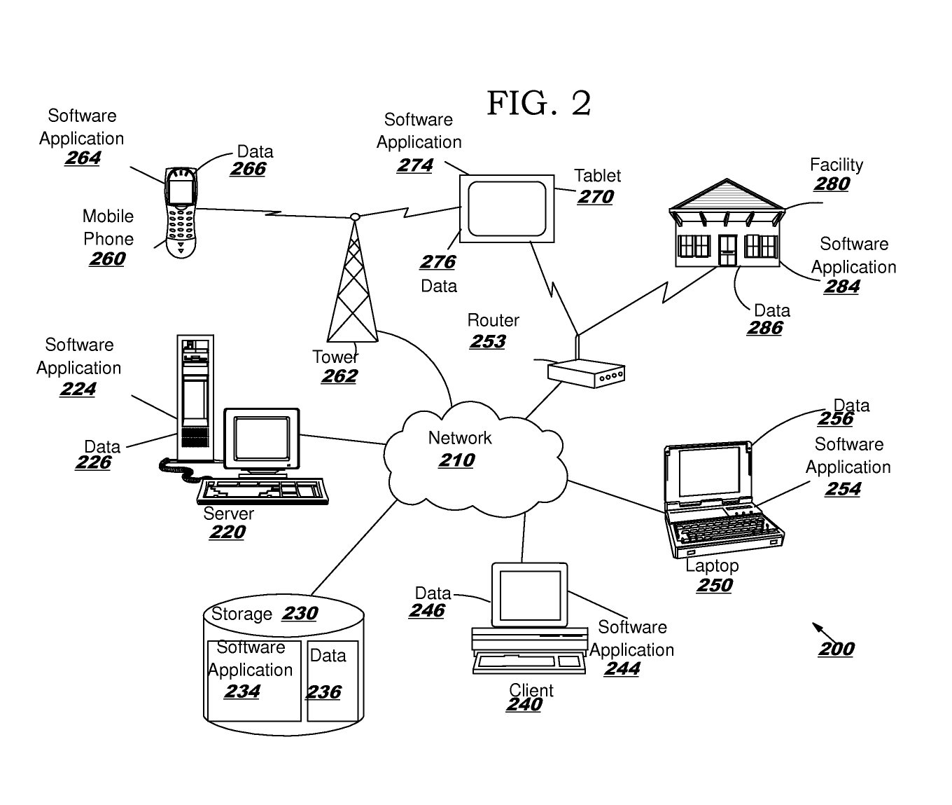

FIG. 2 is a block diagram of a network of data processing systems in which various embodiments may be implemented. Data processing environment 200 is a network of data processing systems such as described above with reference to FIG. 1. Software applications may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, tablet 270 and facility 280 (such as a home or business) are coupled to network 210 including wirelessly such as through a network router 253. A mobile phone 260 and tablet 270 may be coupled to network 210 through a mobile phone tower 262. Data processing systems, such as server 220, client 240, laptop 250, mobile phone 260, tablet 270 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for utilizing markers to manage content across different device types or other software applications and data in accordance with embodiments described herein. Storage 230 may contain software application 234 and a content source such as data 236 for utilizing markers to manage content across different device types. Other software and content may be stored on storage 230 for sharing among various computer or other data processing devices. Client 240 may include software application 244 and data 246. Laptop 250, mobile phone 260 and tablet 270 may also include software applications 254, 264 and 274 and data 256, 266 and 276. Facility 280 may include software applications 284 and data 286. Other types of data processing systems coupled to network 210 may also include software applications. Software applications could include a web browser, email, or other software application that can utilize markers to manage content across different device types.

Server 220, storage unit 230, client 240, laptop 250, mobile phone 260, tablet 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240, laptop 250, and tablet 270. Server 220 may be a single computer system or a set of multiple computer systems working together to provide services in a client server environment. Client 240 and laptop 250 may be clients to server 220 in this example. Client 240, laptop 250, mobile phone 260, tablet 270 facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

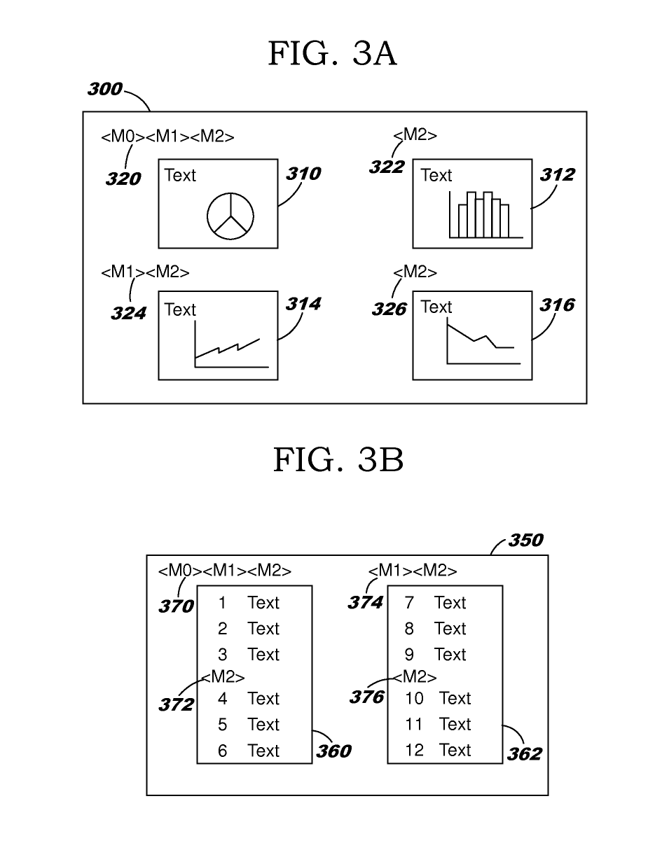

FIGS. 3A and 3B are screen displays of content with markers in accordance with a first embodiment. Many types of content may be utilized including a presentation, a document, a file, a graph, a book, or other type of content.

In FIG. 3A, screen display page 300 includes four different charts for displaying to a user. This includes a pie chart 310, a bar chart 312, a line chart 314 and a second line chart 316. Each of these charts includes some text for describing that chart. These charts may be displayed utilizing a presentation software program, a spreadsheet program, a document processing program, or other type of software. This software may be stored in memory, run by a processor, communicated to multiple devices and device types across wired or wired connections, and displayed on the displays for those devices and device types. However, different displays may have different capabilities and size. For example, some displays such as smart phones may have a smaller screen, limited fonts, and fewer pixels with lower resolution than other displays such as a large LCD (liquid crystal display). As a result, when a presenter is giving a presentation that may be viewed remotely by users on a variety of devices, some of those devices may have less resolution than other devices, making viewing of the presentation difficult. The presenter is able to tailor the display of the information to the different types of devices. These can include a server, a personal computer (PC), a laptop, a tablet, a netbook, a smartphone, a personal digital assistant, a set top box, etc.

For a high resolution display, the presenter may prefer to display all four charts of page 300 at the same time due to the resolution available. For a medium resolution display such as a notepad, the presenter may prefer to display only half of the charts at any given time. For a low resolution display such as a smartphone, the presenter may prefer to display only a quarter of the charts at any given time. This can be accomplished by the use of markers 320, 322, 324 and 326. These markers may be non-displayed special characters, tags, or other indicators which may be embedded in the program used to display the information. These markers are shown in FIG. 3A for illustrative purposes and may be viewed by a presenter in a viewing mode so the presenter can move or otherwise modify the markers. In this example, each marker is shown within the symbols “<” and “>”. In addition, a high resolution display marker is M0, a medium resolution display marker is M1, and a low resolution display marker is M2 in this embodiment. Alternative embodiments may utilize many other types of symbols to represent these markers. Alternative embodiments may also categorize displays differently.

In page 300, all four charts are presented on a high resolution display because <M0> is only found once on the page. Only two charts are shown at a time on a medium resolution display because <M1> is found twice on the page. Charts 310 and 312 are first displayed on a medium resolution display, followed by charts 314 and 316 when the presenter indicates that the next half page is to be display on medium resolution displays. Only one chart is shown at a time on a low resolution display because <M2> is found four times on page 300. Chart 310 is first displayed on a low resolution display, followed by charts 312, 314 and 316 in sequence when the presenter indicates that the next quarter page is to be displayed on low resolution displays. In this embodiment, the low resolution markers are essentially child markers to the medium and high resolution markers.

The presenter may cycle through the displayed charts by pressing a function key. The presenter's display may show all four charts, with an indicator such a highlighting showing what content is displayed on the medium and low resolution displays. Alternatively, the presenter's display may show in separate windows what content is displayed on the high, medium and low resolution displays. When the presenter first starts the presentation, all four charts 310, 312, 314 and 316 may be displayed in the high resolution displays, the first two charts 310 and 312 are shown on the medium resolution displays, and the first chart 310 is shown on the low resolution displays. When the presenter presses the function key for the first time, there is no change for the high and medium resolution displays, but the low resolution display shows the second chart 312. When the presenter presses the function key for the second time, there is no change for the high resolution display, the medium resolution display shows the third and fourth charts 314 and 316, and the low resolution display shows the third chart 314. When the presenter presses the function key for the third time, there is no change for the high and medium resolution displays, and the low resolution display shows the fourth chart 316. When the presenter presses the function key for the fourth time, the presentation moves to a second page such as page 350 of FIG. 3B for all displays.

Page 350 of FIG. 3B includes two columns of text 360 and 362 with markers 370, 372, 374 and 376. Both columns of text are presented on high resolution displays because <M0> is only found once on the page. Only one column of text is shown at a time on a medium resolution display because <M1> is found twice on the page. Column 360 is first displayed on a medium resolution display, followed by column 362 when the presenter indicates that the next half page is to be displayed on medium resolution displays. Only one half of each column is shown at a time on a low resolution display because <M2> is found four times on page 350. On low resolution displays, the top half of column 360 is initially displayed followed by the bottom half of column 360, the top half of column 362, and the bottom half of column 362 in sequence when the presenter indicates that the next quarter page is to be displayed on low resolution displays. The presenter may cycle through the displayed columns by pressing a function key as described above with reference to FIG. 3B.

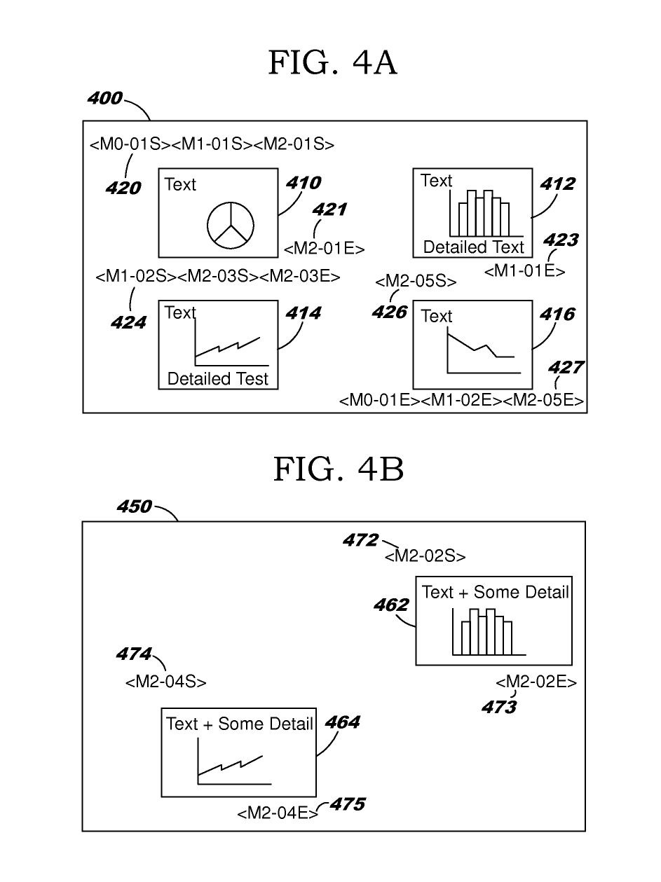

FIGS. 4A and 4B are screen displays of content with markers in accordance with a second embodiment. Many types of content may be displayed including a presentation, a document, a file, a graph, a book, or other type of content. FIGS. 4A and 4B are tightly coupled in this embodiment as described below.

In FIG. 4A, screen display page 400 includes four different charts for displaying to a user. This includes a pie chart 410, a bar chart 412, a line chart 414 and a second line chart 416. Each of these charts includes some text for describing that chart. In the case of bar chart 412 and line chart 414, there is detailed text using a smaller font which may not be displayed properly on low resolution displays. In FIG. 4B, screen display page 450 includes two charts 462 and 464 corresponding to charts 412 and 414. Charts 462 and 464 do not include smaller font text, but use a larger font in supplemented text at the top of each chart. All these charts may be displayed utilizing a presentation software program, a spreadsheet program, a document processing program, or other type of software. This software may be stored in memory, run by a processor, communicated to multiple devices and device types across wired or wired connections, and displayed on the displays for those devices and device types. However, different displays may have different capabilities and size. For example, some displays such as smart phones may have a smaller screen, limited fonts, and fewer pixels with lower resolution than other displays such as a large LCD (liquid crystal display). As a result, when a presenter is giving a presentation that may be viewed remotely by users on a variety of devices, some of those devices may have less resolution than other devices, making viewing of the presentation difficult. The presenter is able to tailor the display of the information to the different types of devices. These can include a server, a personal computer (PC), a laptop, a tablet, a netbook, a smartphone, a personal digital assistant, a set top box, etc.

For a high resolution display, the presenter may prefer to display all four charts of page 400 at the same time due to the resolution available. For a medium resolution display such as a notepad, the presenter may prefer to display only half of the charts at any given time. For a low resolution display such as a smartphone, the presenter may prefer to display only a quarter of the charts at any given time. In addition, the presenter may want to substitute charts 462 and 464 for charts 412 and 414 for low resolution devices. This can be accomplished by the use of markers 420, 421, 423, 424, 426, 427, 472, 473, 474 and 475. These markers may be non-displayed special characters, tags, or other indicators which may be embedded in the program used to display the information. These markers are shown in FIGS. 4A and 4B for illustrative purposes and may be viewed by a presenter in a viewing mode so the presenter can move or otherwise modify the markers. In this example, each marker is shown within the symbols “<” and “>”. In addition, a high resolution display marker is M0, a medium resolution display marker is M1, and a low resolution display marker is M2 in this embodiment. In addition, each marker is numbered including a suffix of S or E indicating whether that marker is a start or end marker. For example, <M0-01S> is the first starter marker for high resolution devices and <M0-01E> is the first end marker. These markers are utilized as described below. Alternative embodiments may utilize many other types of symbols to represent these markers. Alternative embodiments may also categorize displays differently.

In page 400, all four charts are presented on a high resolution display because all four charts are located between <M0-01S> and <M0-01E>. Only two charts are shown at a time on a medium resolution display because two sets of M1 markers (<M1-01S>, <M1-01E>, <M1-02S> and <M1-02E>) are found on the page. Charts 410 and 412 are first displayed on a medium resolution display, followed by charts 414 and 416 when the presenter indicates that the next half page is to be display on medium resolution displays. Only one chart is shown at a time on a low resolution display as shown by the use of sets of M2 markers. Chart 410 is first displayed on a low resolution display as indicated by <M2-01S> and <M2-01E>, followed by chart 462 as indicated by <M2-02S> and <M2-02E>, a synchronization marker <M2-03S><M2-03E> adjoining medium resolution marker <M1-02S>, chart 464 as indicated by <M2-04S> and <M2-04E>, and chart 416 as indicated by <M2-05S> and <M2-05E> in that sequence. In this embodiment, the markers for one type of device may include or substitute charts not shown by other types of devices.

The presenter may cycle through the displayed charts by pressing a function key. The presenter's display may show all four charts, with an indicator such a highlighting showing what content is displayed on the medium and low resolution displays. Alternatively, the presenter's display may show in separate windows what content is displayed on the high, medium and low resolution displays. When the presenter first starts the presentation, all four charts 410, 412, 414 and 416 may be displayed in the high resolution displays, the first two charts 410 and 412 are shown on the medium resolution displays, and the first chart 410 is shown on the low resolution displays. When the presenter presses the function key for the first time, there is no change for the high and medium resolution displays, but the low resolution display shows the second chart 462 on the adjoining page. When the presenter presses the function key for the second time, there is no change for the high resolution display, the medium resolution display shows the third and fourth charts 414 and 416, and the low resolution display skips chart 424 and shows the third chart 464. When the presenter presses the function key for the third time, there is no change for the high and medium resolution displays, and the low resolution display shows the fourth chart 416. When the presenter presses the function key for the fourth time, the presentation moves to another page not shown.

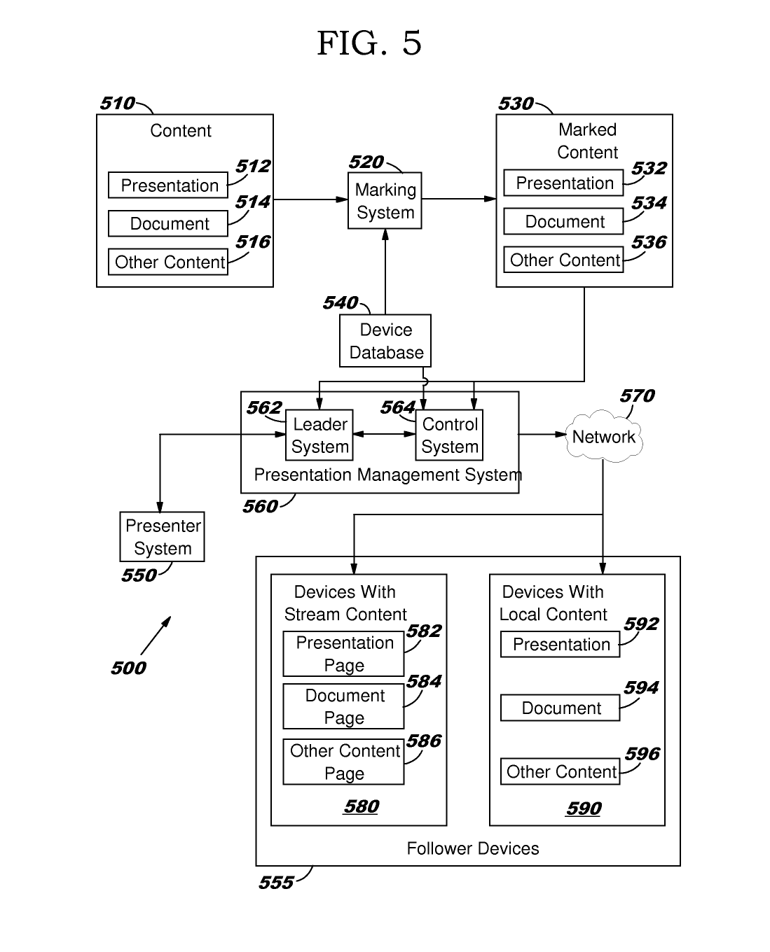

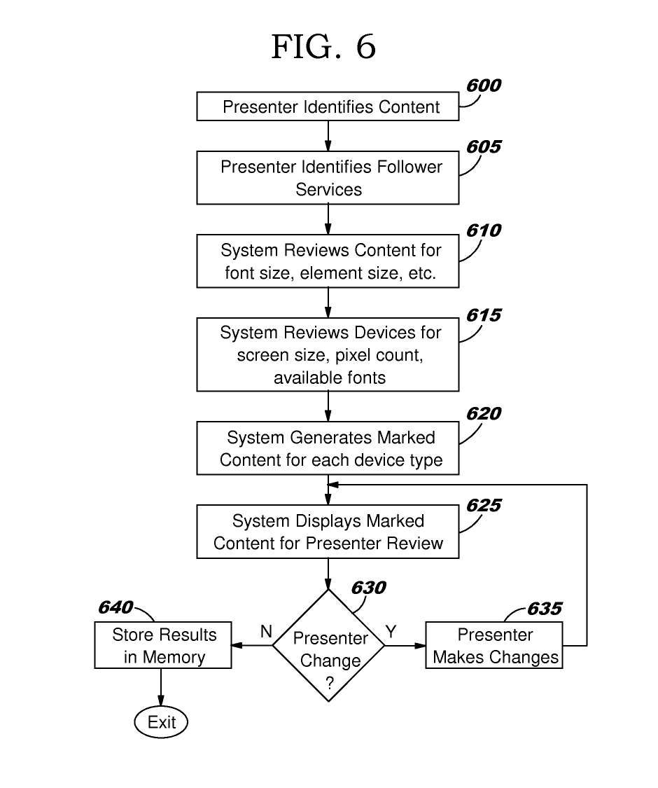

FIG. 5 is a block diagram of a system 500 for setting up and presenting content in which various embodiments may be implemented. Original content 510 may be a presentation 512, a document 514, or other type of content 516 which may be presented across multiple types of devices. A marking system 520 may be utilized to generate marked content 530 for devices identified in a device database 540 with input from a presenter through presenter system 550. A presenter first communicates through presenter system 550 with marking system 520 to identify devices which may receive content 510 during an upcoming presentation. Based on this input, the marking system takes content 510 and generates marked content 530 including a presentation 532, a document 534, or other content 536 with markers tailoring that content for display on different types of devices. The marked content includes recommended formatting such as fonts based on available fonts for each device type as described in device database 540. The presenter may then modify the markers and formatting as desired through the marking system. This process is described in greater detail below with reference with FIG. 6.

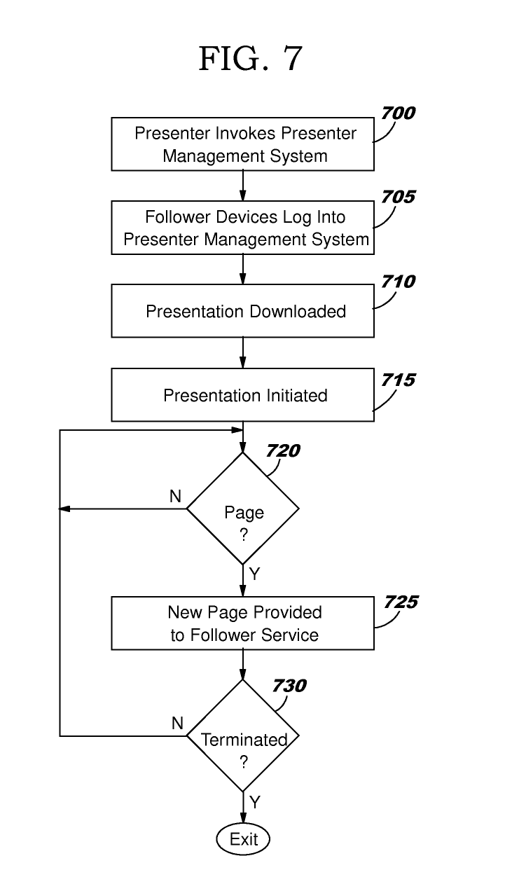

Once the content has been marked and the presenter is ready to begin a presentation, presentation management system 560 is invoked. Presentation management system 560 includes a leader system 562 for communicating with the presenter through presenter system 550 and a control system 564 for providing the content for display by various follower devices 555 identified in the device database and coupled to the control system across a network 570. These follower systems include devices 580 that receive a streamed presentation one page at a time and devices 590 that download the whole presentation and then receive instructions regarding which page to display at any given time. In the case of devices 580 with streamed content, marked content 530 is streamed to each device by control system 564 as that content is displayed in accordance with the resolution for that device. For low resolution devices, the content may be a part of a page where a high resolution device may be provided a larger page for display. The content may be a presentation page 582, a document page 584, or other content page 586 such as a file, a graph, a book, etc. In the case of devices 590 with local content, the marked content 530 is transmitted to each device by control system 564 in a form suitable for display in accordance with the resolution for that device. For low resolution devices, the content may be the whole presentation, but broken into multiple pages in accordance with the resolution for that device. The content may be a presentation 592, a document 594, or other content 596 such as a file, a graph, a book, etc. Once the presentation is started by a presenter through presentation system 550 and leader system 562, control system 564 provides instructions to devices 590 with local content as to when to proceed to the next page. This is described in greater detail with reference to FIG. 7 below.

FIG. 6 is a flow diagram of the operation of a marking system in which various embodiments may be implemented. The marking system is utilized to recommend formatting such as fonts and insert markers into content for presentation to various types of devices. In a first step 600, the presenter (or other user) identifies the content for presentation. This may be a presentation, a document, a file, a graph, a book, or other type of content. In a second step 605, the presenter (or other user) identifies the devices that may receive the presentation referred to herein as follower devices or systems. This can include a server, a personal computer (PC), a laptop, a tablet, a netbook, a smartphone, a personal digital assistant, a set top box, etc. The devices may be included in a preexisting device database that the presenter selects from, or the devices may be individually described by the presenter into a new device database. Alternatively, the presenter may just assume that a range of device types may view the presentation and then work to mark the presentation content to be ready for a wide range of follower devices. In a third step 610, the marking system reviews the content for font size, the size of various elements (such as graph elements), the size of each page, etc. In a fourth step 615, the marking system reviews each devices attributes for screen size, number of pixels for screen resolution, font availability and size, etc. From this information, the devices may be categorized based on ability to display small text, elements, etc. This categorization may be low resolution, medium resolution and high resolution, although other categorizations may be utilized.

Based on the types or categorizations of devices and the content to be presented, in step 620 the marking system then generates marked content with recommended formatting such that it may be properly displayed across multiple types of devices. This can be markings such as described above. Initially the marking may be any sort of pagination that is built into the content. Each page is then compared to each type or category of device to determine whether that page may be properly displayed given available font and element size, screen resolution, etc. If not, then that page may be further subdivided for lower resolution devices such as described above. In addition, certain formatting may be recommended. For example, the fonts in the presentation may differ from the fonts available for certain remote devices. The marking system can recommend certain follower device fonts for usage in such a case. The marking system then displays the marked content to the presenter for review in step 625. This can be done by opening a separate window for each device or category of device and then showing the content as marked. Upon reviewing the content, the presenter is queried or otherwise allowed to indicate that changes are desired in step 630. If changes are desired, then in step 635 the presenter is allowed to make those changes directly to the marked content. This can be through the presenter entering marking directly into the content to be presented, or by other methods of indicating where changes should be made. Once modified, processing returns to step 625 for allowing the presenter to review the modifications. Once the presenter indicates that no more modifications are needed in step 630, then in step 640 the resulting marked content is stored in memory for presentation as desired.

FIG. 7 is a flow diagram of the operation of a presentation management system in which various embodiments may be implemented. This process is invoked by a presenter after the presentation content has been appropriately marked based on the types of follower devices which may receive the presentation.

In a first step 700, the presenter invokes the presentation management system through the presenter system. This will initiate the leader system and control system as well as link those systems with the marked content to be presented. In a second step 705, the various follower devices log into the presentation management system. The follower devices may be doing so at a predesignated time for the presentation. In this step, each follower device contacts the control system and identifies itself so that the control system knows the type or category of each follower device. In a third step 710, the control system downloads the appropriate information for each follower device to initiate the presentation. In the case of follower devices with local content, the marked content is downloaded to each such device. The form of marked content may differ by device. That is, a device with low resolution may only receive content with markers for low resolution devices. In the case of follower devices with streamed content, the first or cover page of the presentation may be downloaded.

In a fourth step 715, the presenter initiates the presentation through the presenter system in communication with the leader system which instructs the control system. This may include live duplex voice communications with each follower device. The control system then instructs each follower device to display the presentation content first page, which may be a cover page. The leader system also provides a leader version of the presentation which may include multiple windows, one window for each category of device, or one window with the portions of a page viewed by a low resolution device highlighted.

In a fifth step 720, the presenter indicates whether to proceed to a next page (or to a previous page if further in the presentation) by pressing a certain key, mouse clicking a certain displayed button, or other forms of indication with the presenter system. The presenter system then passes this indication to the leader system onto the control system. If an indication is received, then processing continues to step 725, otherwise step 720 repeats until an indication is received. In step 725, the control system then notifies the appropriate follower devices with local content of the page change (which may be the next page or a prior page) and streams the next page to the appropriate follower systems with streamed content. Because certain devices have less resolution and may have more pages to display as a result, at certain times only those devices may receive the pagination instruction or the new page of streamed content.

Once a new page is provided, the system determines whether the presentation has terminated in step 730. This can be determined by ascertaining whether the last page was presented or of the presenter indicates that the session is over. If not over, then processing returns to step 720. Otherwise, further processing by the presentation management system ceases.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for utilizing markers to manage content across different device types. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically navigating content on different devices using markers comprising:
identifying a set of device types for receiving content stored in memory;
utilizing a processor to provide markers to the content, the markers being selective by device type; and
displaying on a display a portion of the content on each device type according to the provided markers.

2. The method of claim 1 further comprising:
providing a presentation as content and a list of possible follower devices to a marking system;
receiving recommended format and markers to the presentation for the list of follower devices as device types; and
responsive to user input, modifying the recommended format and marking for the presentation.

3. The method of claim 1 wherein device types are categorized by screen size, pixel count, and available fonts.

4. The method of claim 1 wherein the content is selected from a group consisting of a document, a file, a presentation, a graph, a book, etc.

5. The method of claim 1 wherein the set of device types is selected from a group consisting of a server, a personal computer, a laptop, a tablet, a netbook, a smartphone, a personal digital assistant, and a set top box.

6. The method of claim 1 further comprising a leading system providing markers for displaying the content on follower devices.

7. The method of claim 6 further comprising communicating a most recent marker crossed by the leading system to a first set of follower devices.

8. The method of claim 6 further comprising streaming content according to device type from the leading system to a second set of follower devices based on a most recent marker crossed by the leading system.

9. The method of claim 2 further comprising:
a leading system providing markers for displaying the presentation on the list of possible follower devices;
communicating a most recent marker crossed by the leading system to a first set of the list of possible follower devices;
streaming content according to device type from the leading system to a second set of follower devices based on to a most recent marker crossed by the leading system
wherein the list of possible follower devices is categorized into device types by screen size, pixel count, and available fonts; wherein the presentation is selected from a group consisting of a document, a file, a presentation, a graph, and a book; wherein the set of device types is selected from a group consisting of a server, a personal computer, a laptop, a tablet, a netbook, a smartphone, a personal digital assistant, and a set top box

10. A computer usable program product comprising a computer usable storage medium including computer usable code for use in automatically navigating content on different devices using markers, the computer usable program product comprising code for performing the steps of:
identifying a set of device types for receiving content stored in memory;
utilizing a processor to provide markers to the content, the markers being selective by device type; and
displaying on a display a portion of the content on each device type according to the provided markers.

11. The computer usable program product of claim 10 further comprising:
providing a presentation as content and a list of possible follower devices to a marking system;
receiving recommended format and markers to the presentation for the list of follower devices as device types; and
responsive to user input, modifying the recommended format and marking for the presentation.

12. The computer usable program product of claim 10 wherein device types are categorized by screen size, pixel count, and available fonts.

13. The computer usable program product of claim 10 wherein the content is selected from a group consisting of a document, a file, a presentation, a graph, a book, etc.

14. The computer usable program product of claim 10 further comprising a leading system providing markers for displaying the content on follower devices.

15. The computer usable program product of claim 14 further comprising communicating a most recent marker crossed by the leading system to a first set of follower devices.

16. The computer usable program product of claim 15 further comprising streaming content according to device type from the leading system to a second set of follower devices based on a most recent marker crossed by the leading system.

17. A data processing system for automatically navigating content on different devices using markers, the data processing system comprising:
a processor; and
a memory storing program instructions which when executed by the processor execute the steps of:
identifying a set of device types for receiving content stored in the memory;
utilizing the processor to provide markers to the content, the markers being selective by device type; and
displaying on a display a portion of the content on each device type according to the provided markers.

18. The data processing system of claim 17 further comprising:
providing a presentation as content and a list of possible follower devices to a marking system;
receiving recommended format and markers to the presentation for the list of follower devices as device types; and
responsive to user input, modifying the recommended format and marking for the presentation.

19. The data processing system of claim 17 wherein device types are categorized by screen size, pixel count, and available fonts.

20. The data processing system of claim 17 wherein the content is selected from a group consisting of a document, a file, a presentation, a graph, a book, etc.

21. The data processing system of claim 17 wherein the set of device types is selected from a group consisting of a server, a personal computer, a laptop, a tablet, a netbook, a smartphone, a personal digital assistant, and a set top box.

22. The data processing system of claim 17 further comprising a leading system providing markers for displaying the content on follower devices.

23. The data processing system of claim 22 further comprising communicating a most recent marker crossed by the leading system to a first set of follower devices.

24. The data processing system of claim 22 further comprising streaming content according to device type from the leading system to a second set of follower devices based on a most recent marker crossed by the leading system.
